(19) United States
(12) Patent Application Publication
(10) Pub. No.: US 2023/0011087 A1
(43) Pub. Date: Jan. 12, 2023

(54) BYSTANDER-CENTRIC PRIVACY CONTROLS FOR RECORDING DEVICES

(71) Applicant: Facebook Technologies, LLC, Menlo Park, CA (US)

(72) Inventor: Jeffrey Mekler, San Francisco, CA (US)

(21) Appl. No.: 17/739,886

(22) Filed: May 9, 2022

Related U.S. Application Data
(60) Provisional application No. 63/218,863, filed on Jul. 6, 2021.

(51) Int. Cl. G06F 21/62; H04W 12/63; G06T 7/70; G06V 10/22; H04R 1/32; G10L 25/51; G06T 5/00; G06V 40/16

(52) U.S. Cl. CPC G06F 21/6245; H04W 12/63; G06T 7/70; G06V 10/22; H04R 1/326; G10L 25/51; G06T 5/002; G06V 40/16; G06T 2207/30201

(57) ABSTRACT

A recording device provides bystander-centric privacy controls for authorizing the storage of a bystander's identifying information (e.g., video or audio recordings of the bystander). Before a recording device can store identifying information of bystanders, the bystanders may indicate to the recording device whether they authorize the storage. If the bystanders do not authorize the storage, the recording device may modify the identifying information captured by sensors, such as a video camera or a microphone, such that the identity of the non-authorizing bystander is not identifiable through the modified identifying information. Thus, bystanders are given increased agency over whether they want to be recorded. Further, if the bystanders do not want to be recorded, sensor data that may identify them is modified by the recording device to prevent unwanted exposure of their identity in recorded content.

### CROSS-REFERENCE TO RELATED APPLICATIONS

This application claims the benefit of U.S. Provisional Application No. 63/218,863, filed Jul. 6, 2021, which is incorporated by reference in its entirety.

### FIELD OF THE INVENTION

This disclosure relates generally to sensor data capture, and more specifically to bystander-centric privacy controls for recording devices.

### BACKGROUND

With the adoption of augmented reality (AR) devices, sensors that may record sensitive information will become ubiquitous, creating significant bystander privacy challenges. While current devices often include a blinking light emitting diode (LED) to offer a notification of recording, the blinking light may not be sufficiently noticeable to the public (i.e., bystanders) who are being captured in the recording. In addition, notification may not be sufficient to ensure the safety and privacy of bystanders, particularly for sensitive groups, such as children, individuals with disabilities that prevent detection and/or comprehension of bystander indications, etc. Moreover, notifications may lose meaning when provided by devices that record continuously.

### SUMMARY

Embodiments pertaining to bystander-centric privacy controls for recording devices are described herein. Data capture, such as video or audio recording, is based on bystander privacy controls that are used to determine modifications for the bystander's identifying information that is captured in regions of the sensor data. A recording device may also be referred to as a capturing device. In one example, a capturing device may determine that a bystander does not authorize the recording of their audio and subsequently identify and modify audio that could otherwise be used to identify the bystander. The capturing device may use localization techniques to determine a position of the bystander relative to the capturing device. Using the determined position, the capturing device may identify identifying information of the bystander such as an image of the bystander as captured by a video camera of the capturing device. The capturing device may then modify identifying information to protect the bystander's identity from being recorded without authorization (e.g., blurring images of the bystander's face in recorded videos). Thus, bystanders are given agency over whether they want to be recorded.

In one embodiment, a capturing device includes a sensor configured to capture sensor data that describes a local area having a bystander. The capturing device also includes communications circuitry that is configured to receive, from a device of the bystander, privacy data indicating whether the bystander has authorized the capturing device to store identifying information of the bystander (e.g., images of the bystander's face). The capturing device includes a controller that is configured to determine a position of the bystander from the sensor data, a permission status of the bystander based on the received privacy data, and determine whether the bystander has or has not authorized the capturing device to store identifying information of the bystander. The controller is configured to, in response to determining that the bystander is a non-authorizing bystander, determine a region in the sensor data that includes identifying information of the bystander using the determined position and modify the identifying information in the region of sensor data. The bystander may be unidentifiable by the modified identifying information (e.g., their face is blurred to an extent where the bystander's identity is unrecognizable from the blurred image).

In another embodiment, a method includes capturing, by a sensor of a user's capturing device, sensor data describing a local area having a bystander. Privacy data is received from a device of the bystander, where the privacy data indicates whether the bystander has authorized the capturing device to store identifying information of the bystander. The position of the bystander is determined from the sensor data. A permission status of the bystander is determined based on the received privacy data. In response to determining the bystander is a non-authorizing bystander, a region in the sensor data that includes identifying information of the bystander is determined using the determined position of the bystander. The identifying information in the region is modified such that the bystander is unidentifiable using the modified identifying information.

In yet another embodiment, a non-transitory computer-readable storage medium includes stored instructions that, when executed by a processor of a capturing device, cause the capturing device to capture, by a sensor of the capturing device, sensor data that describes a local area including a bystander. The instructions, when executed, further cause the capturing device to receive privacy data from a device of the bystander, where the privacy data indicates whether the bystander has authorized the capturing device to store identifying information of the bystander. The instructions, when executed, further cause the capturing device to determine a position of the bystander using the sensor data and a permission status of the bystander using the privacy data. The instructions, when executed, further cause the capturing device to, in response to determining that the bystander is a non-authorizing bystander, determine a region in the sensor data that includes identifying information of the bystander and modify the identifying information such that the bystander is unidentifiable using the modified identifying information.

### BRIEF DESCRIPTION OF THE DRAWINGS

FIG. 1 is a perspective view of a headset implemented as an eyewear device, in accordance with one or more embodiments.

FIG. 2 is a block diagram of a capturing device, in accordance with one or more embodiments.

FIG. 3 depicts a user with a capturing device and a bystander with a bystander device, in accordance with one or more embodiments.

FIG. 4 shows a workflow of modifying identifying information by a capturing device, in accordance with one or more embodiments.

FIG. 5 is a flowchart of a method for capturing sensor data for non-authorizing or authorizing users, in accordance with one or more embodiments.

FIG. 6 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A recording device provides bystander-centric privacy controls for authorizing the storage of a bystander's identifying information (e.g., video or audio recordings of the bystander). Before a recording device can store identifying information of bystanders, the bystanders may use their devices to indicate to the recording device whether they authorize the storage. As referred to herein, an authorizing bystander may refer to a bystander who authorizes storage by a capturing device of their identifying information and a non-authorizing bystander may refer to a bystander who does not authorize storage by the capturing device of their identifying information. If the bystanders specify a permission status via their devices indicating that they do not authorize the storage, the recording device may modify the identifying information captured by sensors, such as a video camera or a microphone, such that the identity of the non-authorizing bystander is not identifiable through the modified identifying information. Thus, bystanders are given increased agency over whether they want to be recorded. Further, if the bystanders do not want to be recorded, sensor data that may identify them is modified by the recording device to prevent unwanted exposure of their identity in recorded content.

In one embodiment, the recording device includes a camera that captures images or video of a local area that includes a bystander who has agency over whether the recording device may store their identifying information. The recording device may also be referred to as a capturing device. The capturing device may receive privacy data from a device of the bystander (the bystander device) that is communicatively coupled to the capturing device. The capturing device determines a position of the bystander from the image data or additional data captured by the camera. The capturing device determines, using the privacy data, a permission status indicating whether the bystander authorizes the capturing device to store the bystander's identifying information. In response to determining the bystander is a non-authorizing bystander based on the permission status of the bystander, the capturing device can determine a region of interest within the image data that includes identifying information using the determined position of the bystander. In addition, the capturing device can modify the identifying information within the region of interest of the image data such that a visual representation of the bystander is not identifiable through the modified region of the image data (e.g., shuffling pixels within a bounding box of the region of interest corresponding to the non-authorizing bystander, not rendering data within the bounding box of the region of interest of the image data, etc.).

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

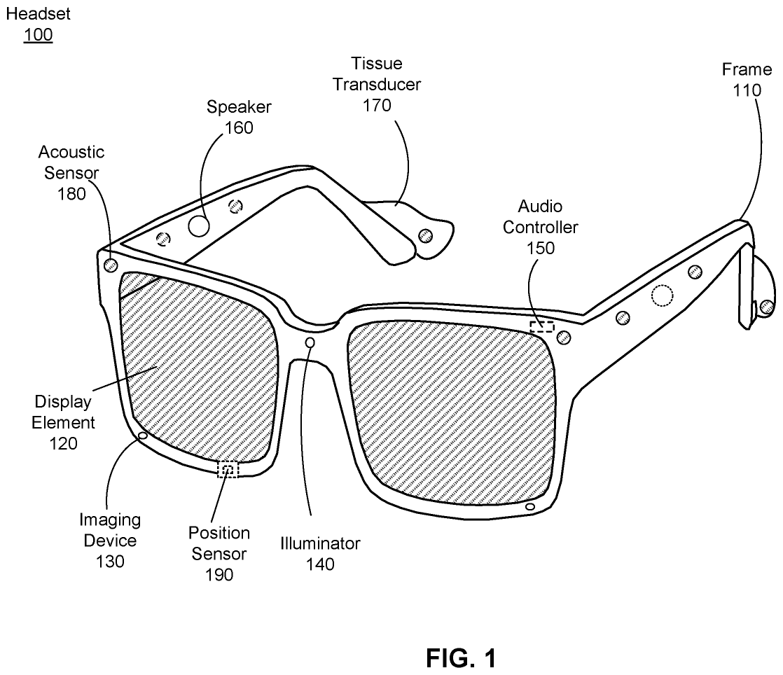

FIG. 1 is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1 illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1 shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

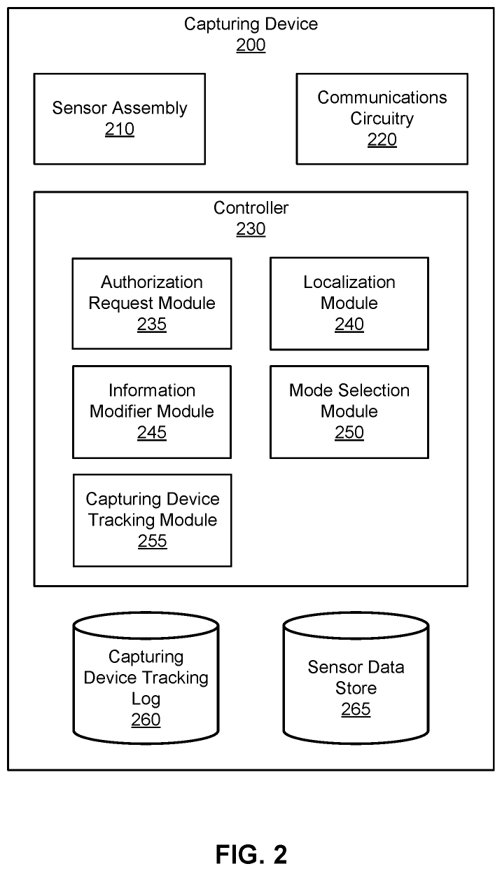

The headset 100 may enable bystanders, using devices communicatively coupled to the headset 100, to specify whether they authorize the headset 100 to store their identifying information captured using one or more of the imaging devices 130 or the acoustic sensor 180. For example, the image devices 130 includes a camera that captures video of a local area and the acoustic sensor 180 includes one or more microphones that can capture audio of the local area and enable audio source localization (e.g., to determine a relative position of a source of a bystander's voice relative to the headset 100). The headset 100 may include a controller that enables the headset 100 to determine whether identifying information of a bystander within the local area may be stored and accordingly, whether to modify the identifying information to protect the privacy of the bystander when storing sensor data captured by the imaging devices 130, the acoustic sensor 180, or a combination thereof. The modification of captured data to increase the privacy of bystanders according permission statuses set by the bystanders is further described with reference to FIGS. 2-5.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

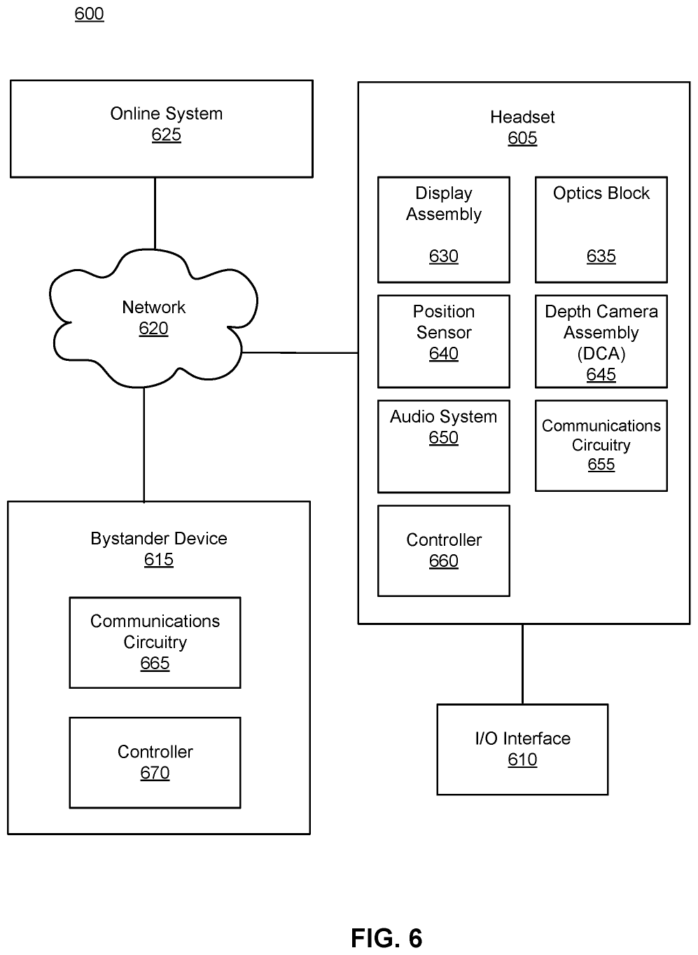

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 6.

FIG. 2 is a block diagram of a capturing device 200, in accordance with one embodiment. The headset 100 of FIG. 1 may be an embodiment of the capturing device 200. The capturing device 200 captures information of a local area while modifying identifying information of bystanders (e.g., images of their faces or recording of their voices) who have not specified permission statuses that authorize the capturing device 200 to store their identifying information. In the embodiment of FIG. 2, the capturing device 200 includes a sensor assembly 210, communications circuitry 220, a controller 230, a sensor data store 265, and a capturing device tracking log 260. Some embodiments of the capturing device 200 have different components than those described here. Similarly, in some cases, functions can be distributed among the components in a different manner than is described here.

The sensor assembly 210 captures information about a local area that includes one or more bystanders. The captured information may include identifying information of a bystander, such as an image of the bystander's face or audio of the bystander's voice. The sensor assembly 210 may be a camera, microphone, any suitable device for capturing information of a local area, or a combination thereof. For example, a combination of the acoustic sensor 180 and the imaging device 130 of the headset 100 may be considered as the sensor assembly 210. In some embodiments, the sensor assembly 210 includes an audio receiver capable of enabling the capturing device 200 to perform sound localization. For example, the sensor assembly 210 includes a software defined receiver that is configured to perform adaptive beamforming. Through sound localization, the capturing device 200 may be configured to determine a position or relative position of a bystander.

The communications circuitry 220 enables communication between the capturing device 200 and other capturing devices, networks, server, or computing devices. The communications circuitry 220 may include a wireless modem for communications with other devices' or servers' communications circuitry. Such communications may involve the Internet or any other suitable communications networks or paths (e.g., the network environment as shown in FIG. 6). Additionally, the communications circuitry 200 may include circuitry that enables peer-to-peer communication of devices, or communication of devices in locations remote from each other.

The communications circuitry 220 enables the capturing device 200 to communicate within a personal area network (PAN) using associated communication protocols (e.g., Bluetooth®, ZigBee®, ultra-wideband (UWB), infrared, ultra-wideband, near-field communication, Wi-Fi Direct®, etc.). For example, the communications circuitry 220 may enable Bluetooth® Low Energy (LE) communications, detecting, or connecting to other Bluetooth® LE devices. The communications circuitry 220 may include a global positioning system (GPS) receiver to use geographic coordinates of the capturing device 200 to determine the position of the capturing device 200 or other devices (e.g., as described with respect to the localization module 240). In some embodiments, the communications circuitry 220 may connect to local area networks (LANs), such as WiFi® networks, and identify other devices connected to the same LAN. The communications circuitry 220 may then enable the capturing device 200 to couple to an online system (e.g., a social networking system) to determine whether devices connected to the same LAN are associated with users having social connections with the user of the capturing device 200.

The communications circuitry 220 may receive privacy data from bystander devices. In some embodiments, before storing identifying information captured by the sensor assembly 210, the capturing device 200 uses the communications circuitry 220 to ensure that the user of the capturing device 200 is authorized by bystanders to store their identifying information. The communications circuitry 220 may transmit broadcast messages (e.g., a Bluetooth® LE advertisement) to the communications circuitry of bystander devices, where the broadcast messages indicate an intention for the capturing device 200 to capture information about the local area. In response to receiving the broadcast message, a bystander device may transmit privacy data to the capturing device 200, which is received by the communications circuitry 220. The communications circuitry 220 of the capturing device 200 may similarly receive broadcast messages from other capturing devices (e.g., a bystander device that is also capable of capturing and storing identifying information) and transmit the privacy data of the capturing device's user to the other capturing devices. The privacy data received by the communications circuitry 220 may indicate whether the bystander authorizes the capturing device 200 to capture and store identifying information about the bystander. Privacy data is further described with respect to the authorization request module 235.

The controller 230 controls operation of the capturing device 200. In the embodiment of FIG. 2, the controller 230 includes an authorization request module 235, a localization module 240, an information modifier module 245, and a mode selection module 250. Some embodiments of the controller 230 have different components than described here. Similarly, functions can be distributed among the components in different manners than described here. For example, some functions of the controller 230 may be performed external to the capturing device 200. An example of an environment of computing devices communicatively coupled to the capturing device 200 is described in reference to FIG. 6.

The authorization request module 235 determines a permission status of a bystander based on received privacy data. A permission may refer to an authorization for a capturing device to store identifying information and a permission status may refer to whether there is authorization for the capturing device to store the identifying information (e.g., the status may be either authorizing or not authorizing). A bystander may select different permission statuses for different capturing devices or users. Similarly, the authorization request module 235 may enable the user of the capturing device 200 to also set a permission status for a particular capturing device or user. The different permission statuses may correspond to different levels of privacy protection. For example, a bystander can select a permission status for a particular user among various options: a first permission status indicating that a user is not allowed to store any identifying information of the bystander, a second permission status indicating that a user may have access to request or obtain permission to store identifying information (e.g., establish a social connection on a social networking system before storing identifying information), or a third permission status indicating that a user is allowed to store identifying information. Additionally or alternatively, a bystander can specify different permission statuses based on a relationship between a user and the bystander. For example, the different levels of privacy protection corresponding to permission statuses may correspond to a degree of connection (e.g., a first degree connection or a second degree connection on a social networking system), a familial relationship, or any suitable familiarity relationship between the user and the bystander. The authorization request module 235 may generate for display (e.g., at a display of the capturing device 200 or a display of a device communicatively coupled to the capturing device 200) a graphical user interface (GUI) enabling the user to specify a capturing device or user and a corresponding permission status.

In some embodiments, the authorization request module 235 requests temporary permission from a bystander device to store identifying information about the bystander. The communications circuitry 220 may be used to transmit this request to the bystander device. The bystander may respond to the request by granting or denying the user temporary permission to store their identifying information. For example, the user of the capturing device 200 wants to record video of a local area for half an hour. The user may specify, through a user input interface of the capturing device 200 or a device communicatively coupled to the capturing device 200, the time duration for which they intend to record information in the local area. The authorization request module 235 may receive this requested time duration, generate broadcast messages during this time duration indicating an intention to record, cause the communication circuitry 220 to transmit the generated broadcast messages, and receive privacy data from bystander devices that receive the generated broadcast messages.

In response to determining a permission status from received privacy data indicating that the bystander device does not grant permission to the capturing device 200 to store identifying information, the authorization request module 235 may generate a request for temporary permission. The authorization request module 235 may receive updated privacy data from the bystander device indicating that the bystander has granted temporary permission. In response, the authorization request module 235 may update the permission status associated with the bystander to indicate that the temporary permission was obtained (e.g., during the half an hour specified by the user, the capturing device 200 may store identifying information of the bystander). The authorization request module 235 may determine whether a duration of time has passed during which the capturing device 200 was allowed temporary permission. In response to determining that the time has passed, the authorization request module 235 may update the permission status of the bystander to indicate that the capturing device 200 is no longer authorized to store identifying information of the bystander. Further, the authorization request module 235 may determine that captured identifying information of the bystander is to be processed to anonymize the bystander (e.g., the processed identifying information cannot be used to identify the bystander). In response to determining that the time has not passed, the authorization request module 235 may maintain the temporary permission status of the bystander and continue to store identifying information.

The authorization request module 235 may use a social graph to determine whether the capturing device 200 is authorized to store identifying information of a bystander. In some embodiments, the capturing device 200 is communicatively coupled to an online system, an example of which is shown in FIG. 6. The online system may maintain a social graph indicating social connections between users of the online system. The social connections may represent a level of familiarity that may be used to determine a permission status. In some embodiments, the privacy data received by the authorization request module 235 may indicate that the permission for the capturing device 200 to record identifying information about a bystander corresponds to whether there is a social connection on a social graph between the capturing device's user and the bystander. The authorization request module 235 may then access the social graph of the online system to determine whether the user and bystander having a social connection on the social graph. In response to determining that there is no social connection on the social graph, the authorization request module 235 may determine that the bystander's permission status for the capturing device 200 does not allow the capturing device 200 to store identifying information of the bystander.

In some embodiments, the authorization request module 235 may enable the user and a bystander to establish a social connection on a social graph, which may change the permission status for the capturing device 200 with respect to the bystander. The authorization request module 235 may access a social network identifier of the bystander from the received privacy data. The social network identifier may belong to an online system and used to identify the bystander as a particular account holder of the online system. The social network identifier may be hashed for additional protection of the bystander's privacy. The authorization request module 235 can query the online system for a social connection (e.g., in a social graph maintained by the online system) between the user of the capturing device 200 and the bystander using the bystander's social network identifier and the user's social network identifier. In response to determining there is an absence of a social connection, the authorization request module 235 may facilitate a process for establishing the social connection.

In some embodiments, the authorization request module 235 may store social network identifiers at a local storage of the capturing device 200 to determine the presence or absence of a social connection between the user and a bystander. For example, the authorization request module 235 may retrieve from an online system the hashed social network identifiers with which the user has a social connection on a social graph and store the retrieved identifiers. With the identifiers stored locally, the capturing device 200 may determine whether there is a social connection between the user and a bystander when the capturing device 200 does not have a network connection with the online system (e.g., to access or query a remotely stored copy of the social graph of the online network).

The authorization request module 235 may display a prompt to the user to create the social connection with the bystander on the online system. For example, the authorization request module 235 may cause a display of the capturing device 200 or a display of a device coupled to the capturing device 200 to display a prompt (e.g., “Would you like to add the person nearby as a friend on your social network?”). In response to receiving a user's selection of the prompt or a user input element related to the prompt (e.g., a button for “Yes” or “No” to create a social connection), the authorization request module 235 may perform a corresponding action. For example, in response to receiving a user selection indicating the user wants to establish a social connection, the authorization request module 235 may transmit instructions to the online system to create request for a social connection from the user to the bystander. In response to receiving a user selection indicating the user does not want to establish a social connection, the authorization request module 235 may determine that the permission status selected by the bystander indicates that they are not authorizing the user to store the bystander's identifying information.

In some embodiments, after the bystander accepts a request to establish a social connection on the online system's social graph, the authorization request module 235 may receive a notification from the online system that the social connection has been established between the user and the bystander. The authorization request module 235 may then update the permission status of the bystander. The updated permission status may indicate that the bystander is an authorizing bystander. That is, the capturing device 200 may store identifying information of the bystander (e.g., images, videos, or audio of the bystander).

The authorization request module 235 may confirm that an authorizing bystander is authorizing the capturing device 200 to store identifying information when operating in a private mode. That is, agnostic of a level of familiarity with the user, the authorization request module 235 may ensure that the bystander is still in control of when the capturing device 200 is recording identifying information. For example, when the user and the bystander are having a private conversation, the authorization request module 235 confirms a permission status to ensure that the user has the bystander's permission to record the private conversation. The capturing device 200 may determine whether the user is likely in a private setting with a bystander. In response to determining that the user is likely in a private setting, the capturing device 200 may operate in a private mode. This is further described with respect to the mode selection module 250. When operating in the private mode, the authorization request module 235 may transmit broadcast message to bystander devices of a request to record information of the local area. The bystander devices may generate a prompt for the bystander to specify their approval or denial of the recording (e.g., generated by the authorization request modules at the bystander devices). This prompt may be generated at the bystander devices or client devices (e.g., smartphones) communicatively coupled to the bystander devices. The authorization request module 235 may receive the bystander's approval or denial of the request to store identifying information and determine a corresponding permission status (e.g., store the audio of the private conversation if the bystander has approved the request).

The localization module 240 can determine the identifying information within information captured by the sensor assembly 210 of a local area. By distinguishing the identifying information that the capturing device 200 is not authorized to store from the sensor data captured by the sensor assembly 210, the localization module 240 can enable localized modification (e.g., censorship) of information captured by the sensor assembly 210. For example, the sensor assembly 210 may capture video of multiple bystanders, where some bystanders transmit privacy data indicating that the capturing device 200 is authorized to store their identifying information while other bystanders transmit privacy data indicating that the capturing device 200 is not authorized. The localization module 240 may determine, within the captured video, the identifying information of bystanders are non-authorizing bystanders. The information modifier module 245 may then modify identifying information identified by the localization module 240 to protect the privacy of the bystanders who have requested not to be recorded. In this way, the localization module 240 enables the capturing device to capture at least some information of the local area while protecting the privacy of some bystanders rather than completely halt any information capture.

The localization module 240 may use one or more of audio or image data to determine the identifying information of non-authorizing bystanders within information captured by the sensor assembly 210 of a local area. The localization module 240 may receive a list of bystander devices of non-authorizing bystanders (e.g., a list of bystanders within a personal area network proximity to the capturing device 200) from the authorization request module 235. The localization module 240 may determine the locations of the bystander devices of non-authorizing bystanders. In some embodiments, the localization module 240 receives the location of a bystander device from a remote server that maintains the locations of capturing devices, bystander devices, or a combination thereof. For example, the devices may be used to access an online network that requests permission of the devices to access their location during use of the online network. The online network may track the locations of the devices, and the capturing device 200 can access the tracked locations.

After determining the locations of the non-authorizing bystander's devices, the localization module 240 may determine the positions of the non-authorizing bystander relative to the capturing device 200. The position of the bystander may correspond to a location with which the bystander's image is captured or a location from which audio from the bystander is emitted. The localization module 240 may determine the positions of authorizing devices in a similar manner as described with respect to determining the positions of non-authorizing devices. For example, the localization module 240 determines an angular offset between an optical axis of a camera of the capturing device 200 faces and a line connecting the capturing device 200 and the non-authorizing bystander's device (e.g., a non-authorizing bystander device behind the user capturing a video may be one hundred and eighty degrees offset from the optical axis and out of the camera's field of view). The localization module 240 may determine an orientation of a camera of the capturing device 200 (e.g., the direction in which the camera points) using inertial measurement unit data of the capturing device 200. The orientation may be used to determine the direction that the camera is facing (e.g., the orientation of the optical axis) and the angular offset of a non-authorizing bystander's device relative to the optical axis of the camera. Using the angular offset between a non-authorizing bystander's device and the camera of the capturing device 200 capturing sensor data, the localization module 240 may estimate a location of the non-authorizing bystander device within a field of view of a camera of the capturing device 200.

The localization module 240 may use radio frequency signals, in addition or alternative to one or more of image or audio information captured by the sensor assembly 210, to determine a position of a bystander device (e.g., a position relative to the capturing device 200). The localization module 240 may use signal processing techniques such as beamforming, direction of arrival (DOA), time of arrival (TOA), time difference of arrival (TDOA), time of flight (ToF), any suitable sound localization technique, or combination thereof. The localization module 240 may use signals received by the communications circuitry 220 using a short-range protocol, such as UWB, to determine the relative location of a bystander using one or more of the aforementioned signal processing techniques. In some embodiments, the localization module 240 may use received audio information captured by the sensor assembly 210 to identify sources of audio within the local area (e.g., directions of bystanders relative to the microphone of the sensor assembly 210). The localization module 240 may use the current location of the capturing device 200 to determine the locations of sound sources relative to the capturing device 200.

In some embodiments, the localization module 240 may determine a location of a non-authorizing bystander device relative to an array of microphones (e.g., an array including bottom-facing and forward facing microphones of a headset) using the orientation of the capturing device 200, the location of the capturing device 200, and the location of the non-authorizing bystander device. For example, the localization module 240 may determine that the headset is being worn over the user's eyes and microphones of the headset are oriented in a particular way (e.g., bottom-facing microphone is facing downward, front-facing microphone is oriented north). The localization module 240 uses the locations of the capturing device 200 and the location of the non-authorizing bystander device to determine a direction between the two devices. The localization module 240 may then use the determined direction between the two devices and the orientation of the microphones to determine the location of the non-authorizing bystander device relative to the array of microphones. The localization module 240 may identify (e.g., using beamforming) the sound from the direction of the location of the non-authorizing bystander device.

The capturing device 200 may operate in an environment with a single bystander within its proximity (e.g., within a personal area network proximity). The localization module 240 may determine the relative position of the bystander to the capturing device 200 using a sound localization technique. For example, the localization module 240 may identify an audio signal associated with sound from the bystander in the local area using beamforming. The localization module 240 may instruct a software defined receiver of the sensor assembly 210 to tweak steering vector parameters, iterating on directions of potential sound sources until identifying a signal having a relatively large strength (e.g., having a decibel magnitude over a threshold). The localization module 240 may determine a likelihood that the signal corresponds to a bystander. For example, the localization module 240 may apply a machine learned model to the audio signal, where the model is trained on samples of human voices, and determine the likelihood that the signal is that of a human voice. After identifying that the signal is that of a human voice, the localization module 240 may determine a relative position of the bystander using the identified audio signal. The localization module 240 may determine a position of the bystander (e.g., a geographic region in which the bystander may be located) using the relative position and GPS coordinates of the capturing device.

The information modifier module 245 modifies identifying information in sensor data captured by the sensor assembly 210. The information modifier module 245 may modify the identifying information within a region of interest in the captured sensor data coinciding with a position of the non-authorizing bystander, as identified by the localization module 240. The information modifier module 245 may modify identifying information of a bystander such that the bystander is not identifiable from the processed identifying information. For example, the information module 245 may blur the image of a non-authorizing bystander's face in a video captured by the sensor assembly 210. In another example, the information module 245 may change the pitch of a non-authorizing bystander's voice in a video captured by the sensor assembly 210. Other examples of processing identifying information include masking (e.g., blocking a bystander's face with a large, gray square), bleeping (e.g., changing the user's speech to a single frequency tone), shuffling (e.g., shuffling pixels within a bounding box surrounding the bystander's face or shuffling bits of audio spoken by the bystander), any suitable form of anonymizing a user's identity from recorded information, or a combination thereof.

The information modifier module 245 may determine a region of interest within the captured sensor data having identifying information. The information modifier module 245 may use a bystander's position, as determined by the localization module 240, to determine the region of interest. In some embodiments, determining the region of interest includes determining a portion of the captured sensor data that includes a portion of a bystander's face, a portion of the bystander's body, a portion of the bystander's voice, any suitable information of the bystander captured by the sensor assembly 210 that may identify the bystander, or a combination thereof.

The information modifier module 245 may modify identifying information by processing image data, audio data, or a combination thereof. The information module 245 may identify image data corresponding to identifying information in the region of interest in captured sensor data. In one example of modifying identifying information in the form of image data, the information module 245 modifies an image of the bystander. The information module 245 identifies the image of a human as being an image of the bystander. In some embodiments, the information module 245 may use computer vision, machine learning, or any suitable form of artificial intelligence to perform facial recognition on image data as captured by the sensor assembly 210. The information module 245 may limit the area of image data that, for example, a machine learned model is applied to using the region of interest (e.g., applying the model to a region of interest of image data including a bystander's face rather than to the entire image which includes vehicles, buildings, and other objects). Thus, the information modifier module 245 may reduce the processing resources expended on otherwise a larger amount of image data. After identifying the presence of a face within a region of interest, the information module 245 may use reference images of a bystander to identify the bystander. For example, the information modifier module 245 may use a social network identifier received in privacy data from the bystander to access a profile image of the bystander's face and determine a level of similarity between the profile image and the image recognized in the sensor data.

In another example of modifying identifying information in the form of audio data, the information module 245 processes the bystander's voice. The information modifier module 245 identifies a region of interest in audio data captured by the sensor assembly 210. The region of interest may be a source of sound coinciding with the position of the bystander as determined by the localization module 240. The information modifier module 245 may process the audio sourced from the position of the bystander. For example, the information modifier module 245 may use a sound localization technique to distinguish the audio coming from the direction of the position of the bystander. The information modifier module 245 may instruct the sensor assembly 210, which may include a software-defined receiver configured to perform a sound localization technique such as adaptive beamforming, to increase the signal strength of audio signals received from the direction of a bystander relative to other bystanders. For example, the sensor assembly 210 may use a steering vector to create a receiving polar pattern that increases the received signal strength of the non-authorizing bystander's audio relative to authorizing bystanders. The sensor assembly 210 may include audio receivers (e.g., microphones) that capture the audio of a local area without beamforming and audio receivers that may be allocated to perform beamforming and focus on a desired audio signal to be anonymized. The information modifier module 245 may process the audio signals associated with the bystander (e.g., the signals received from the direction of the bystander) to modify captured sensor data such that the bystander is not identifiable through the processed audio signal (e.g., the bystander's voice is not recognizable). For example, the information modifier module 245 may process the audio signal by modulating the frequency of the audio signals received from the direction of the bystander. The information modifier module 245 may then sum the frequency modulated audio signal with audio signals captured without beamforming to mask or distort the bystander's audio. In another example, the information modifier module 245 may process the audio signal within captured sensor data by subtracting the audio signals received using beamforming (e.g., signals from the direction of the bystander) from the audio signal received without beamforming. In this way, the information modifier module 245 may diminish the volume level of the bystander's voice so that the bystander is effectively muted.

In some embodiments, the information modifier module 245 may determine not to modify a bystander's identifying information when the authorization request module 235 has received temporary authorization from a bystander to store their identifying information. For example, the authorization request module 235 may receive permission from a bystander to store their identifying information for a predetermined duration of time and during that duration of time, change the permission status of the bystander to indicate that the bystander is an authorizing bystander. In response, the information modifier module 245 does not modify the identifying information and the identifying information of the bystander may pass, unmodified, to a storage space (e.g., local memory of the capturing device 200 or to a remote server) for access by one or more users. The authorization request module 235 may determine when the predetermined duration of time expires and when the time expires, change the permission status of the bystander to indicate that the bystander is a non-authorizing bystander. When the bystander is non-authorizing, the information modifier module 245 may modify the identifying information such that the bystander is not identifiable through the modified identifying information.

To further promote bystander privacy, the capturing device 200 may determine to modify identifying information of bystanders captured in sensor data that have not been determined to be associated with a bystander device. For example, the information modifier module 245 may determine to modify identifying information of a user that does not have a device capable of providing their privacy data or has their device in a state (e.g., powered off) that cannot provide their privacy. In some embodiments, the information modifier module 245 may determine which bystanders are likely not associated with bystander devices. For example, the localization module 240 determines positions of bystander devices within proximity of the capturing device 200 and the information modifier module 245 may determine that a number of bystanders represented by image or audio data of the sensor data outnumber the number of proximal bystander devices. The information modifier module 245 may estimate likely regions in which device-less bystanders are located (e.g., by distinguishing them from regions in which the information modifier module 245 determines there are bystander devices) and modify the identifying information of bystanders within these regions.

In some embodiments, the authorization request module 235 may receive updated privacy data from a bystander device that reflects the bystander's request for a different level of privacy relative to a permission status that the authorization request module determined from previously received privacy data. For example, the bystander may use their bystander device to send updated privacy data requesting additional privacy and to be excluded from photos or videos captured of them. In this example, the authorization request module 235 can determine that a bystander has authorized storage of their identifying information using a first set of privacy data received from the bystander device, but subsequently receives a second set of privacy data from the bystander device that indicates an updated permission status that the capturing device 200 is not authorized to store the bystander's identifying information. The second set of privacy data may be received after the capturing device 200 has already captured and stored the bystander's identifying information in accordance with the previous permission status. The information modifier module 245 may determine to store the unmodified identifying information in the sensor data store 265 for a predetermined period of time (e.g., a period of time within a range of one minute to one hour) before transmitting the unmodified identifying information for access by others (e.g., before uploading to an online system for social networking). The user or the bystander may provide instructions to the authorization request module 235 specifying the amount of time to which the predetermined period of time is set. By storing the unmodified identifying data for the predetermined period of time, the capturing device 200 can account for a change of permission status from a bystander that requests additional privacy after previously specifying a more lenient permission status (e.g., permission for public access to their identifying information). The information modifier module 245 may, in response to receiving the updated permission status indicating that the capturing device 200 cannot store the bystander's identifying information, modify the identifying information stored within the sensor data store 265 so that the bystander is not identifiable from the modified identifying information.

In another example of receiving privacy data from a bystander device that indicates the bystander has modified a requested level of privacy, the capturing device 200 may receive updated privacy data including a request to relax previously specified privacy measures and to be included in photos or videos captured of them (e.g., where they might have already been anonymized by the capturing device 200). In this example, the authorization request module 235 can determine that a bystander has previously not authorized storage of their identifying information using a first set of privacy data received from the bystander device, but subsequently receives a second set of privacy data from the bystander device that indicates an updated permission status that the capturing device 200 is indeed authorized to store the bystander's identifying information. The second set of privacy data may be received after the capturing device 200 has already captured and modified the bystander's identifying information in accordance with the previous permission status. The information modifier module 245 may determine to temporarily store the unmodified identifying information in the sensor data store 265 for a predetermined period of time (e.g., a period of time within a range of one minute to one hour) before deleting unmodified identifying information, honoring the bystander's privacy request not to store their identifying information for access by others, including the user of the capturing device 200. The user or the bystander may provide instructions to the authorization request module 235 specifying the amount of time to which the predetermined period of time is set. By storing the unmodified identifying data for the predetermined period of time, the capturing device 200 can account for a change of permission status from a bystander that requests relaxing previously established privacy measures after previously specifying a more strict permission status (e.g., prohibiting others to store or access the bystander's identifying information). The information modifier module 245 may, in response to receiving the updated permission status indicating that the capturing device 200 can store the bystander's identifying information, replace the portions of the videos or images with modified identifying information with the unmodified identifying information that was temporarily stored within the sensor data store 265 so that the bystander is identifiable from the identifying information. In this way, the bystander can change their mind to include themselves (e.g., their face or voice) in photos or videos even if the capturing device had previous instructions to anonymize their identity or had already processed the captured sensor data to anonymize their identity.

When operating in a private mode, as determined by the mode selection module 250, the information modifier module 245 may determine to modify a bystander's identifying information. For example, the bystander may be under an impression that the bystander and user are having a private conversation and does not want to be recorded, regardless of a level of familiarity with the user. The mode selection module 250 may determine that the user and the bystander are in a private setting and instruct the information modifier module 245 to modify the bystander's identifying information despite the bystander historically selecting a permission status indicating that the bystander is authorizing. In some embodiments, the information modifier module 245 may stop modifying the identifying information when operating in a private mode in response to the authorizing request module 235 receiving a confirmation from the bystander that their identifying information may continue to be recorded in the private setting.

The mode selection module 250 determines whether to operate in a particular mode (e.g., a private mode). An operation mode may correspond to a combination of settings or instructions that the capturing device 500 operates in accordance with depending on a context of operation. Examples of operating modes include a private mode or a public mode. The mode selection module 250 may use a public mode of operation by default. In one example of defaulting to a public mode of operation, when not operating in a private mode, the mode selection module 250 may determine that the capturing device 500 operates in a public mode. A public mode of operation may correspond to an instruction to determine a permission status of a bystander and reuse the permission status (e.g., without confirming whether the permission status has changed) for a period of time (e.g., during a session of capturing sensor data or for a predetermined period of time such as twenty four hours since last determining the permission status).

A private mode of operation may correspond to an instruction to communicate with bystander devices associated with previously authorizing bystanders to reconfirm that the bystander is still authorizing when in a private setting. In some embodiments, the user may have interactions with bystanders in a private setting. Private settings may include non-public locations such as a user's home or in an office of a business. Private settings may include public locations that do not have a threshold number of people within the public location (e.g., an area of a park without other visitors except the user of capturing device 200 and a bystander). By determining whether to operate in a private mode, the mode selection module 250 may prevent unwanted storage of a bystander's identifying information in the event that the bystander, regardless of a level of familiarity with the user of the capturing device 200, perceived a sense of privacy (e.g., confidentiality) during an interaction with the user. Thus, the mode selection module 250 further enables the capturing device 200 to increase privacy around the recording of sensitive identifying information of bystanders.

The mode selection module 250 may determine a likelihood of the capturing device 200 operating in a private setting to determine whether to operate in a private mode. The mode selection module 250 may use the sensor assembly 210 to determine information about the environment in which the capturing device 200 operates. The sensor assembly 210 may capture image or audio data about the environment, which the mode selection module 250 may use to determine factors that contribute to a decision of whether the capturing device 200 is operating in a private setting. Factors may include the number of people depicted in image data captured by the sensor assembly 210 or the ambient noise level of the audio captured by the sensor assembly 210. The mode selection module 250 may apply artificial intelligence to recognize human features (e.g., facial recognition) within image data, count the number people within the operating environment based on the recognized features, and determine whether the count exceeds a threshold for a private setting (e.g., a maximum of four persons). The mode selection module 250 may determine the ambient noise level by processing audio data (e.g., performing peak detection of received audio signals, removing detected peaks, and determining an average magnitude) and comparing the ambient noise level to a threshold for a private setting (e.g., thirty decibels). The mode selection module 250 may, in addition to determining a number of people or ambient noise level of an environment, determine whether the environment is a private setting using a model that maps a location of the capturing device 500 or a bystander device to private or public property. In response to determining that the operating environment is a private setting, the mode selection module 250 may determine to operate in a private mode. In response to determining that the operating environment is not a private setting (e.g., the ambient noise level is greater than thirty decibels), the mode selection module 250 may determine not to operate in a private mode. When operating in a private mode, the authorization request module 235 and the information modifier module 245 may operate accordingly, as described in the descriptions of the respective modules.

The capturing device tracking module 255 tracks a list of the capturing devices that have likely captured identifying information of the user of the capturing device 200. The capturing device tracking module 255 may access the messages broadcast by other capturing devices requesting permission to store identifying information or broadcasting an intent to record their local area. The capturing device tracking module 255 may identify the source of the broadcasted messages (e.g., another capturing device that transmitted a broadcast message to the capturing device 200) through sender identifiers included within the broadcasted messages. Additionally, capturing devices (e.g., authorization request modules of the capturing devices) may include social network identifiers in broadcast messages indicating their intention to record their local area. The capturing device tracking module 255 may record identifiers of the senders (e.g., by their social network identifiers) and thus, track which capturing devices may have captured identifying information of the user of the capturing device 200. The capturing device tracking module 255 may provide for display the record of which capturing devices may have captured identifying information. The capturing device tracking module 255 may store the records of which capturing devices have broadcasted an intent to store identifying information of the user in the capturing device tracking log 260. In some embodiments, the records may include a date, time, location, a duration with which the bystander device was within a local area with the capturing device (e.g., using proximity determined using short range communications sensors), or any suitable information describing a context in which a capturing device and a bystander device interacted for purposes of capturing sensor data.

The sensor data store 265 stores identifying information captured by the sensor assembly 210. The sensor data store 265 may additionally store modified identifying information, as processed by the information modifier module 245, that anonymizes non-authorizing bystanders. The information stored in the sensor data store 265 may be accessed by the user of the capturing device 200, a bystander, an online network, any suitable recipient of the captured sensor data, or combination thereof. The user of the capturing device 200 may specify access permissions for the information stored in the sensor data store 265. For example, the user may specify that only users of an online network who have established a social connection on a social graph of the online network with the user may access the stored information. In some embodiments, the sensor data store 265 may be located remote from the capturing device 200 (e.g., a remote server communicatively coupled to the capturing device 200). As referred to herein, the storage or recording of identifying information is persistent in manner such that the stored information may be accessed later by a user. This type of storage may be contrasted with a more temporal storage mechanism such as a computing device's random access memory storage.

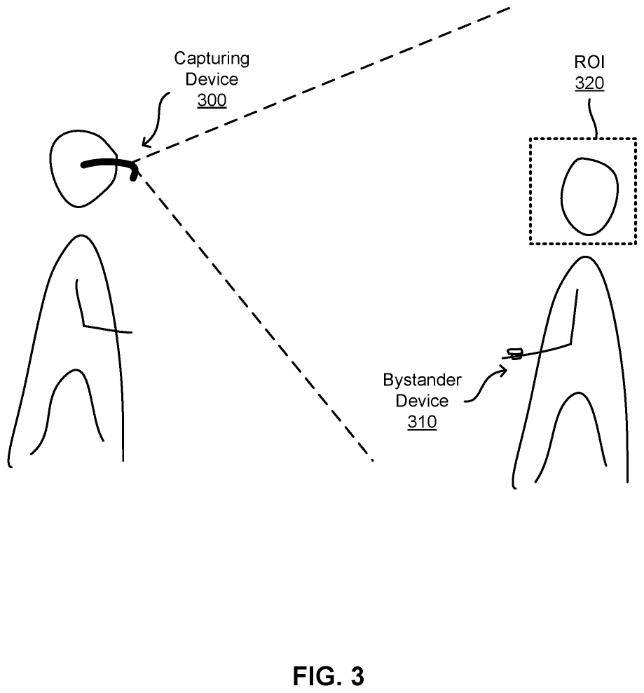

FIG. 3 depicts a user with a capturing device 300 and a bystander with a bystander device 310, in accordance with at least one embodiment. The capturing device 300 may be the headset 100 or the capturing device 200. The capturing device 300 may include one or more sensors that capture an environment. The bystander device 310 is depicted as a smart watch, but may alternatively be a headset, a smartphone, a computer, or any suitable portable computing device. Sensors may include image sensors, audio sensors, or the like. In some embodiments, the capturing device 300 is configured to perform localization (e.g., using ultra-wideband (UWB) or some other short-range radio based technology). The capturing device 300 may further include a hardware and/or software integration layer. The capturing device 300 may store or be configured to access data pertaining to a social graph of the user.

A bystander is an individual who is in a local area of a device such that a sensor of the device may capture content (e.g., images of the individual and/or speech of the individual) from them. The bystander device 310 may be configured to perform localization (e.g., using UWB or some other short-range radio based technology). The bystander device 310 may enable the bystander to select from various permission statuses indicating whether one or more capturing devices, including the capturing device 300, may record identifying information of the bystander. In some embodiments, the bystander device 310 may also be a capturing Examples of permission statuses include authorizing the public to record their identifying information, authorizing certain individuals to record their identifying information (e.g., individuals with which the bystander has social connections on an online system), and not authorizing the public to record their identifying information. Identifying information may be information from which the identify of an individual may be determined or inferred, either directly or indirectly. Identifying information may include a portion of an individual's face, a portion of an individual's body, a portion of an individual's voice, some other information unique to that individual, or a combination thereof.

In some embodiments, the bystander device 310 may generate a log of capturing devices that have captured the bystander. This may provide additional notice that the bystander's identifying information has been recorded. The bystander device 310 may provide the bystander with an interface for selecting a permission status for the capturing device 300. The bystander may specify a permission status based on a relationship between the user of the capturing device 300 and the bystander. For example, the bystander may specify that the permission status is based on a degree of connection (e.g., a first degree or second degree connection on an online system), a familial relationship, or the like.

In one embodiment, the sensor of the capturing device 300 captures sensor data, such as image or audio, describing a local area that includes a bystander. The bystander device 310 may transmit to the capturing device 300 privacy data associated with the bystander in response to receiving a request or notification from the capturing device 300 reflective of an intent to record information of the local area, which may include identifying information of the bystander. The privacy data may include the permission status set by the bystander for the capturing device 300. The privacy data may include information about a social connection between the user of the capturing device 300 and the bystander (e.g., a social network identifier of the bystander), demographic information of the bystander (e.g., an age range into which the bystander falls), or the like. Demographic information such as an age range may cause capturing devices to determine that the information modifier module of the capturing devices should modify identifying information (e.g., to anonymize the identity of a child within a recorded video to protect their privacy).

The capturing device 300 may determine a position of the bystander from sensor data captured by a sensor of the capturing device 300. The capturing device 300 may determine position using data received from the bystander device 310 (e.g., via UWB), sensor data measured by a sensor of the capturing device 300, data received by the capturing device 300 (e.g., GPS coordinates), or a combination thereof. The capturing device 300 may determine a permission status of the bystander based on the privacy data associated with the bystander. For example, the privacy data may specify a permission status based on the presence or absence of a social connection on a social graph (e.g., the permission status indicates that the capturing device 300 is authorized by the bystander if the social connection is present). In some embodiments, individuals included in the user's social graph are each associated with a permission status. The capturing device 300 may transmit requests to bystanders to receive explicit authorization for their identifying information to be recorded. Alternatively or additionally, the permissions status of the bystander may be based on a social graph associated with the bystander.

In response to determining that bystander is a non-authorizing bystander, the capturing device 300 may determine a region of interest 320 of the captured sensor data that includes identifying information of the bystander using the position of the bystander. In some embodiments, determining a region of interest 320 of the sensor data that includes identifying information of the bystander includes determining a portion of the sensor data that represents (e.g., depicts or emits a sound of) at least a portion of the bystander's face, at least a portion of the bystander's body, the bystander's voice, any suitable recordable information identifying the bystander, or a combination thereof. The capturing device 300 may modify the identifying information in the region of interest 320 to make the bystander unidentifiable from the modified identifying information. In one example, modifying the identifying information includes shuffling pixels of image data within a bounding box corresponding to the region of interest 320. In another example, the modifying the identifying information includes not rendering data within the bounding box corresponding to the region of interest 320. In embodiments where audio is captured by the capturing device 300, the capturing device 300 may change the frequency of the audio associated with (e.g., emitted from) the region of interest 320, not render the audio associated with the region of interest 320, shuffle bits of the audio associated with the region of interest 320, or the like.

In response to the capturing device 300 determining that the bystander is an authorizing bystander, the capturing device 300 may modify the region of interest 320 of the sensor data based on additional data. Additional data may include, but is not limited to data in a social graph of the user of capturing device 300, a determination of operation within a private setting, or any suitable context information precipitating the anonymization of the bystander's identifying information. In some embodiments, the capturing device 300 may not modify identifying information in response to determining that the bystander is an authorizing bystander. The capturing device 300 may store the identifying information as originally captured within the sensor data. For example, the capturing device 300 may store a video of an authorizing bystander at a remote server of an social networking system for access by users of the social networking system.

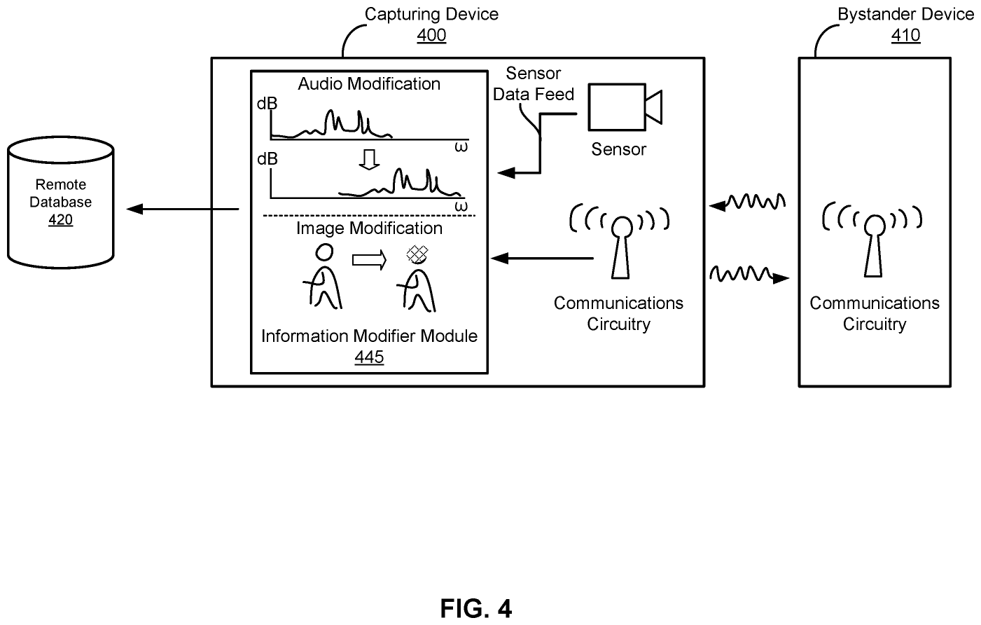

FIG. 4 shows a workflow of modifying identifying information by a capturing device 400, in accordance with at least one embodiment. The capturing device 400 may identify the permission status of a bystander device 410, localize a region of interest within sensor data having identifying information of the bystander, and de-identify the identifying information (e.g., cause the bystander to be unidentifiable by modified identifying information). While two devices are depicted in FIG. 4, in alternative or additional embodiments, there may be additional capturing devices or bystander devices.

Communications circuitries of the capturing device 400 and the bystander device 410 may be used to determine the relative position between the two devices (e.g., using short range wireless communication protocols such as Bluetooth or UWB for positioning). The capturing device 400 and the bystander device 410 may be proximal (e.g., within a broadcasting range of short range wireless communication protocols) to one another, and the localization features on both devices may identify each other and their relative physical locations. The capturing device 400 includes a sensor for capturing information about a local area, which may be recorded (e.g., video, audio, etc.).

In some embodiments, after the capturing device 400 determines the relative position of the bystander device 410, the capturing device 400 may determine whether identifying information of the bystander has been captured within the sensor data feed based on the relative position of the bystander device 410. For example, the capturing device 400 may determine whether the bystander is located within a field of view of an image sensor, a hearing range of a microphone, or a combination thereof. Localization may be performed using one or more localization algorithms, machine learned models, heuristics, or the like.

The capturing device 400 may determine whether to modify identifying information of the bystander based on a permission status determined based on privacy data transmitted by the bystander device 410 to the capturing device 400. An authorization request module of the capturing device 400 may determine whether the capturing device 400 is authorized to store identifying information. In response to determining that the bystander device 410 has not authorized the capturing device 400 to store identifying information, the capturing device 400 modifies captured sensor data within a determined region of interest that includes identifying information of the bystander (e.g., raw image feed or raw audio feed of the bystander). In some embodiments, the capturing device 400 may limit or further limit sharing of information of the bystander with the user of the capturing device 400. For example, when raw image data is captured, the capturing device 400 may blur regions of the image that contain the bystander, such as the portions of the bystander's face or body, not render data in the regions containing the bystander, any suitable modification to the image causing the depiction of the bystander to be unidentifiable by the modifications, or a combination thereof. In another example, when raw audio data is captured, the integration layer may change a frequency of the audio within the region of interest, not render the audio within the region of interest, shuffle bits of the audio within the region of interest, any suitable modification to the audio causing the bystander's audio to be unidentifiable by the modifications, or a combination thereof. In some embodiments, the identifying information modified by the capturing device 400 may be provided to additional software or hardware components of the capturing device 400 for further processing or storage. For example, the modified identifying information may be provided to the remote database 420 for storage.

In some embodiments, the sensor is a camera. In these embodiments, a camera captures a raw image of a local area that includes a bystander. The capturing device 400 may receive privacy data from the bystander device 410 that is communicatively coupled to the capturing device 400. The capturing device 400 determines a position of the bystander from the image data or additional data captured by the camera. The capturing device 400 determines a permission status of the bystander based on privacy data associated with the bystander. In response to determining the bystander is a non-authorizing bystander based on the permission status of the bystander, the capturing device 400 determines a region of interest within the image data that includes identifying information using the determined position of the bystander. In addition, the information modifier module 445 of the capturing device 400 can modify the identifying information within the region of interest of the image data such that a visual representation of the bystander is not identifiable through the modified region of the image data (e.g., shuffling pixels within a bounding box of the region of interest corresponding to the non-authorizing bystander, not rendering data within the bounding box of the region of interest of the image data, etc.). As depicted in FIG. 4, the information modifier module 445 may cause the image of the bystander's head to be blurred such that the face of the bystander is not recognizable through the blurring.

In some embodiments, the sensor is a microphone. A microphone of the capturing device 400 captures audio data describing a local area that includes a bystander. The capturing device 400 receives privacy data from the bystander device 410 that is communicatively coupled to the capturing device 400. The capturing device 400 determines a position of the bystander from the audio data or additional data captured by the microphone. For example, one or more portions of the audio data including the bystander's voice may be determined. The capturing device 400 determines a permission status of the bystander based on the privacy data associated with the bystander. In response to determining that the bystander is a non-authorizing bystander based on the permission status of the bystander, the capturing device 400 may determine a region of interest in the audio data that includes identifying information using the determined position of the bystander. In addition, the information modifier module 445 of the capturing device 400 may modify the identifying information within the region of interest in the audio data (e.g., by changing a frequency, not rendering the audio within the region of interest, shuffling bits of the audio, etc.). As depicted in FIG. 4, the information modifier module 445 may shift the frequency response of the audio signal such that the bystander's true pitch is not identifiable through the modified audio.

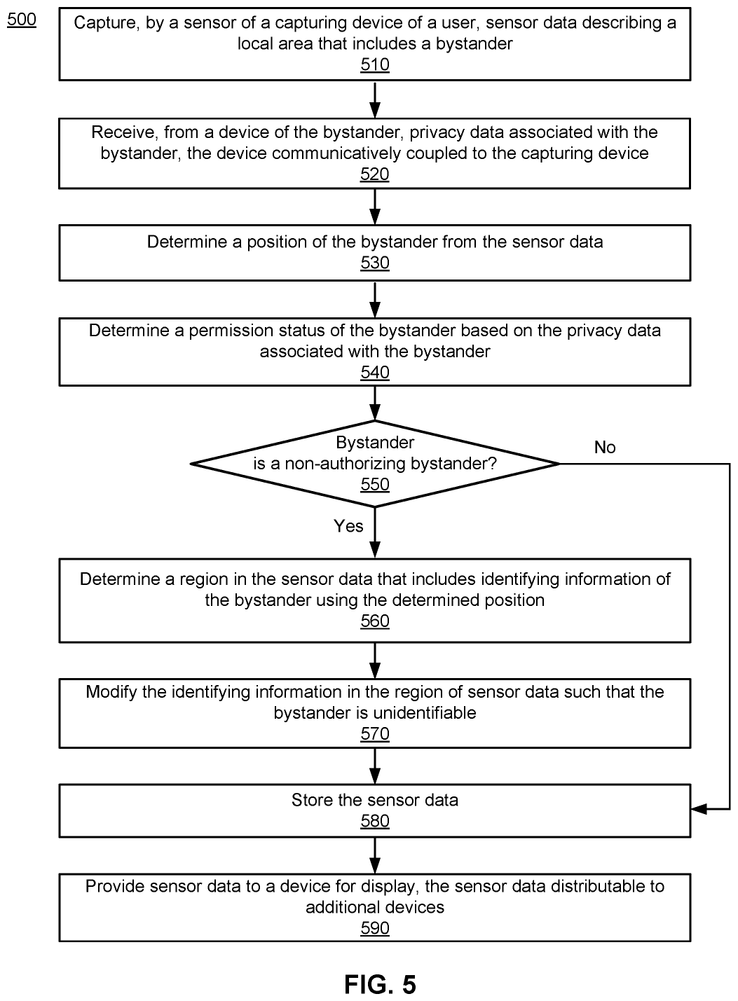

FIG. 5 is a flowchart of a method 500 for capturing sensor data for non-authorizing or authorizing users, in accordance with one or more embodiments. The process shown in FIG. 5 may be performed by components of a capturing device (e.g., the capturing device 200). Other entities may perform some or all of the steps in FIG. 5 in other embodiments. Embodiments may include different and/or additional steps, or perform the steps in different orders.

The capturing device captures 510 sensor data describing a local area that includes a bystander. For example, a video camera of a headset captures video and audio of a park that includes a park visitor.

The capturing devices receives 520 privacy data associated with the bystander from a device of the bystander. The bystander's device is communicatively coupled to the capturing device. Following the previous example, the headset may receive, from a smartphone of the bystander, privacy data indicating that capturing devices belonging to users who are connected with the bystander on a social graph of an online system (e.g., a social networking system) may be authorized to store identifying information of the bystander and those who are not connected are not authorized.

The capturing device determines 530 a position of the bystander from the sensor data. For example, a localization module of the headset of the previous example determines a position of the bystander using a combination of beamforming and proximity detection via a short range communication protocol (e.g., UWB).

The capturing device determines 540 a permission status of the bystander based on the privacy data associated with the bystander. Following the previous example, an authorization request module of the headset may determine, using a social graph of a social network and a social network identifier of the bystander received in the privacy data, that there is an absence of a social connection between the bystander and the user of the capturing device.

The capturing device determines 550 whether the bystander is an authorizing bystander or a non-authorizing bystander. For example, the headset of the previous example may use the absence of the social connection between the user and the bystander to determine that the bystander is a non-authorizing bystander. In response to determining that the bystander is a non-authorizing bystander, the capturing device may determine 560 a region in the sensor data that includes identifying information of the bystander using the determined position of the bystander. Continuing the previous example, the determines a region in the captured video data depicting the face of the non-authorizing bystander and a portion of the audio data including the voice of the non-authorizing bystander. The capturing device modifies 570 the identifying information in the region of the sensor data such that the bystander is unidentifiable. For example, the headset of the previous example blurs the face of the non-authorizing bystander and changes the frequency of the audio signal corresponding to the voice of the bystander such that the bystander is not identifying from their blurred face or their modified voice.

The capturing device stores 580 the sensor data. The capturing device may store the sensor data that includes the modified identifying information in response to determining that the bystander is a non-authorizing bystander. Alternatively the capturing device may store the sensor data that includes identifying information of the bystander in response to determining that the bystander is an authorizing bystander.

The capturing device provides 590 the sensor data to a device for display. The sensor data can be distributable or accessible to additional devices. For example, the headset of the previous example provides the video data with the non-authorizing bystander's blurred face and distorted voice to an online system for storage, where the video data may be accessed by the user of the headset or additional users of the online system. However, the bystander's identity is protected within the provided video data because the headset has made the bystander unidentifiable through the modified identifying information.

FIG. 6 is a system 600 that includes a headset 605, in accordance with one or more embodiments. In some embodiments, the headset 605 may be the headset 100 of FIG. 1. The system 600 may operate in an artificial reality environment (e.g., a virtual reality environment, an augmented reality environment, a mixed reality environment, or some combination thereof). The system 600 shown by FIG. 6 includes the headset 605, an input/output (I/O) interface 610, a bystander device 615, the network 620, and the online system 625. While FIG. 6 shows an example system 600 including one headset 605 and one I/O interface 610, in other embodiments any number of these components may be included in the system 600. For example, there may be multiple headsets each having an associated I/O interface 610, with each headset communicating with a bystander device 615. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments.

The headset 605 includes the display assembly 630, an optics block 635, one or more position sensors 640, the DCA 645, the audio system 650, communications circuitry 655, and the controller 660. Some embodiments of headset 605 have different components than those described in conjunction with FIG. 6. For example, the headset 605 may include a sensor such as a microphone. Additionally, the functionality provided by various components described in conjunction with FIG. 6 may be differently distributed among the components of the headset 605 in other embodiments, or be captured in separate assemblies remote from the headset 605.

The display assembly 630 can display content to the user in accordance with data received from a console. The display assembly 630 displays the content using one or more display elements (e.g., the display elements 120). A display element may be, e.g., an electronic display. In various embodiments, the display assembly 630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 635.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUS, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The DCA 645 generates depth information for a portion of the local area. The DCA includes one or more imaging devices and a DCA controller. The DCA 645 may also include an illuminator. Operation and structure of the DCA 645 is described above with regard to FIG. 1A.

The audio system 650 provides audio content to a user of the headset 605. The audio system 650 is substantially the same as the audio system 200 describe above. The audio system 650 may comprise one or acoustic sensors, one or more transducers, and an audio controller. The audio system 650 may provide spatialized audio content to the user. In some embodiments, the audio system 650 may request acoustic parameters from a mapping server over the network 620. The acoustic parameters describe one or more acoustic properties (e.g., room impulse response, a reverberation time, a reverberation level, etc.) of the local area. The audio system 650 may provide information describing at least a portion of the local area from e.g., the DCA 645 and/or location information for the headset 605 from the position sensor 640. The audio system 650 may generate one or more sound filters using one or more of the acoustic parameters received from the mapping server, and use the sound filters to provide audio content to the user.

The communications circuitry 655 and the controller 660 of the headset 605 may perform functions similar to that performed by the controller 230 and the communications circuitry 220, respectively, of FIG. 2. Thus, the headset 605 is configured to capture sensor data and modify identifying information, as needed based on permission statuses specified by bystanders, to ensure that the privacy of the bystanders may be secured.

The I/O interface 610 is a device that allows a user to send action requests and receive responses from a console or other suitable controller of the headset 605 (e.g., a smartphone). An action request is a request to perform a particular action. For example, an action request may be an instruction to start or end capture of image or video data, request permission from the bystander device 615 to record identifying information of the bystander, or an instruction to perform a particular action within an application. The I/O interface 610 may include one or more input devices. Example input devices include: a keyboard, a mouse, a game controller, or any other suitable device for receiving action requests and communicating the action requests to a console. An action request received by the I/O interface 610 is communicated to a console, which performs an action corresponding to the action request. In some embodiments, the I/O interface 610 includes an IMU that captures calibration data indicating an estimated position of the I/O interface 610 relative to an initial position of the I/O interface 610. In some embodiments, the I/O interface 610 may provide haptic feedback to the user in accordance with instructions received from the console. For example, haptic feedback is provided when an action request is received, or the console communicates instructions to the I/O interface 610 causing the I/O interface 610 to generate haptic feedback when the console performs an action.

The bystander device 615 provides privacy data to the headset 605 for determining whether the bystander of the bystander device 615 authorizes the headset to record identifying information of the bystander. In the example shown in FIG. 6, the bystander device 615 includes communications circuitry 665 and a controller 670. Some embodiments of the bystander device 615 have different modules or components than those described in conjunction with FIG. 6. For example, the bystander device may include one or more sensors. The communications circuitry 665 may perform similar functions as performed by the communications circuitry 220 of FIG. 2. Similarly, the controller 670 may perform similar functions as performed by the controller 230 of FIG. 2.

The network 620 couples the headset 605 and/or the bystander device 615 to the online system 625. The online system 625 may be a social networking system maintaining a social graph including social connections between users of the social networking system. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, an HRTF for the user, etc. Privacy settings (or “access settings”) for a user data element may be stored in any suitable manner, such as, for example, in association with the user data element, in an index on an authorization server, in another suitable manner, or any suitable combination thereof. One example of a privacy setting is a permission status that a bystander selects for a capturing device.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A capturing device comprising:
a sensor configured to:
capture sensor data describing a local area that includes a bystander;
communications circuitry configured to:
receive, from a device of the bystander, privacy data associated with the bystander, the device communicatively coupled to the capturing device; and
a controller configured to:
determine a position of the bystander from the sensor data,
determine a permissions status of the bystander based on the privacy data associated with the bystander, and
responsive to a determination that the bystander is a non-authorizing bystander based on the permissions status of the bystander:
determine a region in the sensor data that includes identifying information of the bystander using the determined position, and
modify the identifying information in the region of sensor data, the bystander unidentifiable using the modified identifying information.

2. The capturing device of claim 1, wherein the controller is further configured to:
responsive to a determination that the bystander is a temporary authorizing bystander based on the permissions status of the bystander:
transmit a request to the device, the request requesting permission to store the identifying information for a predetermined duration of time;
receive authorization from the bystander to store the identifying information for the predetermined duration of time; and
responsive to a determination that the predetermined duration of time has expired, modify the identifying information in the region of the sensor data.

3. The capturing device of claim 1, wherein the controller is further configured to:
receive a first broadcast message from a proximate capturing device of a proximate user, the first broadcast message indicating an intention to capture sensor data, the first broadcast message including at least one of an identifier of the proximate capturing device or a hashed social networking identifier of the proximate user; and
in response to receipt of the first broadcast message:
generate a second broadcast message including privacy data associated with the user, and
transmit the second broadcast message.

4. The capturing device of claim 1, wherein the controller is further configured to:
identify an audio signal associated with sound from the bystander in the local area using beamforming;
determine a relative position of the bystander using the identified audio signal; and
determine the position of the bystander using the relative position and global positioning system (GPS) coordinates of the capturing device.

5. The capturing device of claim 1, wherein the controller is further configured to:
determine to operate in a private mode;
in response to operating in the private mode:
request permission from proximate devices to store audio data associated with users of the proximate devices, the proximate devices within the local area and a personal area network range of the capturing device,
in response to receiving approvals of the request from the proximate devices, store the audio data associated with users of the proximate devices, and
in response to receiving a rejection of the request from at least one of the proximate devices:
determining a plurality of regions in the sensor data that includes identifying information of users of the at least one of the proximate devices; and
modifying identifying information in the plurality of regions of sensor data, the users of the at least one of the proximate devices unidentifiable using the modified identifying information in the plurality of regions.

6. The capturing device of claim 5, wherein the controller is further configured to:
determine at least one of an ambient background volume level or a number of people within the local area; and
determine to operate in the private mode in response to at least one of the ambient background volume level falling below a threshold volume level or the number of people falling below a threshold number of people.

7. The capturing device of claim 1, wherein the controller is further configured to:
identify image data corresponding to identifying information in the region in the sensor data; and
process the image data, the processed image data representing at least one of a blurred or censored image of the face of the bystander.

8. The capturing device of claim 1, wherein the controller is further configured to:
identify audio data corresponding to identifying information in the region in the sensor data; and
process the audio data, the processed audio data representing at least one of a frequency modulated voice of the bystander.

9. The capturing device of claim 1, wherein the controller is further configured to:
access a hashed social network identifier from the privacy data associated with the bystander, the hashed social network identifier associated with an online system with which the user holds an account;
display a prompt to the user to create a social connection with the bystander on the online system;
responsive to selection of the prompt, receive a notification from the online system that the social connection has been established between the user and the bystander; and
update the permission status of the bystander, the updated permission status indicating the bystander is an authorizing bystander.

10. The capturing device of claim 1, wherein the received privacy data includes a hashed social network identifier of the bystander, the hashed social network identifier associated with an online system, and wherein the controller is further configured to:
access a social graph using the hashed social network identifier, the social graph representing social connections between users of the online system;
identify an absence of a social connection between the user and the bystander in the social graph; and
determine the absence of the social connection corresponds to the permission status indicating that the bystander is the non-authorizing bystander rejecting storage of the identifying information.

11. A method comprising:
capturing, by a sensor of a capturing device of a user, sensor data describing a local area that includes a bystander;
receiving, from a device of the bystander, privacy data associated with the bystander, the device communicatively coupled to the capturing device;
determining a position of the bystander from the sensor data;
determining a permission status of the bystander based on the privacy data associated with the bystander; and
responsive to determining the bystander is a non-authorizing bystander based on the permissions status of the bystander:
determining a region in the sensor data that includes identifying information of the bystander using the determined position, and
modifying the identifying information in the region of sensor data, the bystander unidentifiable using the modified identifying information.

12. The method of claim 11, further comprising:
responsive to determining that the bystander is a temporary authorizing bystander based on the permissions status of the bystander:
transmitting a request to the device, the request requesting permission to store the identifying information for a predetermined duration of time;
receiving authorization from the bystander to store the identifying information for the predetermined duration of time; and
responsive to determining that the predetermined duration of time has expired, modifying the identifying information in the region of the sensor data.

13. The method of claim 11, further comprising:
receiving a first broadcast message from a proximate capturing device of a proximate user, the first broadcast message indicating an intention to capture sensor data, the first broadcast message including at least one of an identifier of the proximate capturing device or a hashed social networking identifier of the proximate user; and
in response to receipt of the first broadcast message:
generating a second broadcast message including privacy data associated with the user, and
transmitting the second broadcast message.

14. The method of claim 11, further comprising:
identifying an audio signal associated with sound from the bystander in the local area using beamforming;
determining a relative position of the bystander using the isolated audio signal; and
determining the position of the bystander using the relative position and global positioning system (GPS) coordinates of the capturing device.

15. The method of claim 11, further comprising:
determining to operate in a private mode;
in response to operating in the private mode:
requesting permission from proximate devices to store audio data associated with users of the proximate devices, the proximate devices within the local area and a personal area network range of the capturing device,
in response to receiving approvals of the request from the proximate devices, storing the audio data associated with users of the proximate devices, and
in response to receiving a rejection of the request from at least one of the proximate devices:
determining a plurality of regions in the sensor data that includes identifying information of users of the at least one of the proximate devices; and
modifying identifying information in the plurality of regions of sensor data, the users of the at least one of the proximate devices unidentifiable using the modified identifying information in the plurality of regions.

16. The method of claim 15, further comprising:
determining at least one of an ambient background volume level or a number of people within the local area; and
determining to operate in the private mode in response to at least one of the ambient background volume level falling below a threshold volume level or the number of people falling below a threshold number of people.

17. The method of claim 11, further comprising:
identifying image data corresponding to identifying information in the region in the sensor data; and
processing the image data, the processed image data representing at least one of a blurred or censored image of the face of the bystander.

18. The method of claim 17, further comprising:
accessing a hashed social network identifier from the privacy data associated with the bystander, the hashed social network identifier associated with an online system with which the user holds an account;
displaying a prompt to the user to create a social connection with the bystander on the online system;
responsive selecting the prompt, receiving a notification from the online system that the social connection has been established between the user and the bystander; and
updating the permission status of the bystander, the updated permission status indicating the bystander is an authorizing bystander.

19. The method of claim 11, further comprising:
identifying audio data corresponding to identifying information in the region in the sensor data; and
processing the audio data, the processed audio data representing at least one of a frequency modulated voice of the bystander.

20. A non-transitory computer-readable storage medium comprising stored instructions, the instructions when executed by a processor of a capturing device, causing the capturing device to:
capture, by a sensor of the capturing device of a user, sensor data describing a local area that includes a bystander;
receive, from a device of the bystander, privacy data associated with the bystander, the device communicatively coupled to the capturing device;
determine a position of the bystander from the sensor data;
determine a permissions status of the bystander based on the privacy data associated with the bystander; and
responsive to determining the bystander is a non-authorizing bystander based on the permissions status of the bystander:
determine a region in the sensor data that includes identifying information of the bystander using the determined position, and
modify the identifying information in the region of sensor data, the bystander unidentifiable using the modified identifying information.
